(19) United States
(12) Patent Application Publication
(10) Pub. No.: US 2003/0094357 A1
(43) Pub. Date: May 22, 2003

(54) Press-button switch structure

(76) Inventor: Wan Lai Lin, Taipei (TW)

Correspondence Address: WAN LAI LIN, P.O. BOX 26-757, TAIPEI, 106, TW

(21) Appl. No.: 10/002,368

(22) Filed: Nov. 20, 2001

(51) Int. Cl. H01H 13/14

(52) U.S. Cl. 200/341

(57) ABSTRACT

A press-button switch structure, comprising a body, which further having a elastic piece coupled to the body, a contact portion being disposed at an end of the elastic piece, a press portion being disposed at the other end with respect to the contact portion, and a bouncing section being disposed between the contact portion and the press portion. Further, the body is soldered onto the circuit of a printed circuit board such that when the user presses on the press portion, the elastic portion will bounce back, and the contact portion will be drawn downward and contacted with second circuit on the printed circuit board. Therefore, the first circuit will be connected to second circuit. By repeatedly pressing the contact portion, we can connect the first circuit and generate signals for inputting the related numerals, text, or symbols.

### BACKGROUND OF THE INVENTION

1. Field of the Invention

The present invention relates to a press-button switch structure, comprising a body, which further having a elastic piece coupled to the body, a contact portion being disposed at an end of the elastic piece, a press portion being disposed at the other end with respect to the contact portion, and a bouncing section being disposed between the contact portion and the press portion. Furthermore, the body is soldered onto the circuit of a printed circuit board such that when the user presses on the press portion, the elastic portion will bounce back, and the contact portion will be dragged downward and will contact with second circuit on the printed circuit board.

2. Description of the Prior Art

In general, electronic devices such as handsets, calculators, etc have a casing, and the casing contains all kinds of electronic components and circuit board required for the normal operation of those electronic devices. A set of press-button switches are disposed on the casing, so that the user can repeatedly press on those switches for the input of numerals, related text, and symbols.

Traditional press-button switches are generally elastic piece switch, conductive rubber switch, or silver coating switch; wherein a plurality of hemispherical metallic elastic piece are disposed on the circuit board of the electronic device, so that when the user presses those metallic elastic pieces, the metallic elastic pieces will touch individual circuits on the circuit board for electrical connection. Until the user releases the metallic elastic piece, the metallic elastic piece returns to its original position and those circuits will return to the originally disconnected status. However, the distance of the metallic elastic piece being pressed is short, and its texture is poor. Furthermore, when the metallic elastic piece has been used for a while (about 500,000 times), the elastic pieces will crack or loose its elasticity, and the user will not be able to use it anymore.

Further, the conductive rubber switch comprises a plurality of elastic hollow rubber press-button switches, which are disposed on the circuit board of the electronic device, and such rubber press button comprises a conductor at the contact portion of the circuit board so that when the user presses the rubber switches, the rubber switches deform and the contact portion of each conductor touches second circuit on the circuit board, and thus connects other circuits. Until the user releases the rubber press-button switch, the rubber switch will resume its original shape so that the first circuit can return to its originally disconnected status. However, the resistance of the conductor of the conductive rubber switch gradually gets larger and larger after being used for a while, and the conductivity gets poorer as well.

Further, the silver coating switch has a thin film, and a plurality of silver coatings are disposed on the film and the contact portion of the circuit board such that when the user presses the silver coating section of the film, the silver coating will touch second circuit on the circuit board, and connects the first circuit. Until the user releases the film, the silver coating will be separated from the first circuit, and it returns to the originally disconnected status. However, when the silver coating switches have been used for a long time, its elasticity will become poor, and the contact between the silver coating and the first circuit may have poor connection. After the silver coating has been used for a while, its resistance gradually increases, and its conductivity worsens.

In view of the shortcomings of the prior art mentioned above, the inventor of the present invention based on years of experience accumulated from the engagement in the related industry conducted extensive research to resolve the foregoing shortcomings and invented the press-button switch structure of the present invention.

Therefore, the primary objective of the present invention is to provide a press-button switch structure, comprising a body, which is coupled to a elastic piece on which there is a bouncing section. The body is soldered onto the first circuit of a printed circuit board such that when the user presses the elastic piece, the elastic portion will bounce back, and the elastic piece will be drawn downward and contacted with second circuit on the printed circuit board. Therefore, the circuit will be connected. By repeatedly pressing the contact portion, we can connect the circuit and generate signals for inputting the related numerals, text, or symbols.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows a three-dimensional diagram of the disassembled parts of the structure according to the present invention.

FIG. 2 shows a three-dimensional diagram showing the external look of the present invention and its circuit.

FIG. 3 is a diagram showing the actions taken in the present invention.

### DETAILED DESCRIPTION OF THE PREFERRED EMBODIMENT

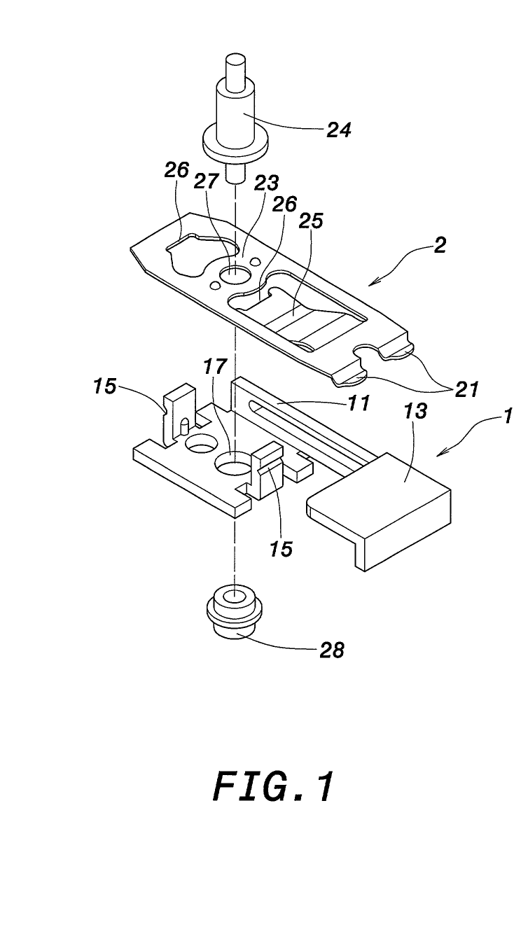

The present invention relates to a press-button switch structure. Please refer to FIG. 1, and the structure comprises a body 1 made of electrical conductive material, and the body 1 is coupled to a elastic piece 2 made of electrical conductive material, and a contact portion 21 is extended downward from an end of the elastic piece 2, and the bottom surface of the contact portion 21 is gold plated in order to increase its conductivity. A press portion 23 is disposed on the opposite end of the contact portion 21 of the elastic piece 2, and a press shaft 24 is disposed on the press portion 23, and a elastic portion is disposed between the contact portion 21 and the press portion 23. The elastic portion is formed by pressing on the elastic piece 2, and the elastic portion is integrally combined with the elastic piece 2. The other end faces towards the lower part of the elastic piece 2 and is extended to a second hook portion 26. A second hook portion 26 is disposed on the other side of elastic portion 25 of the elastic piece 2.

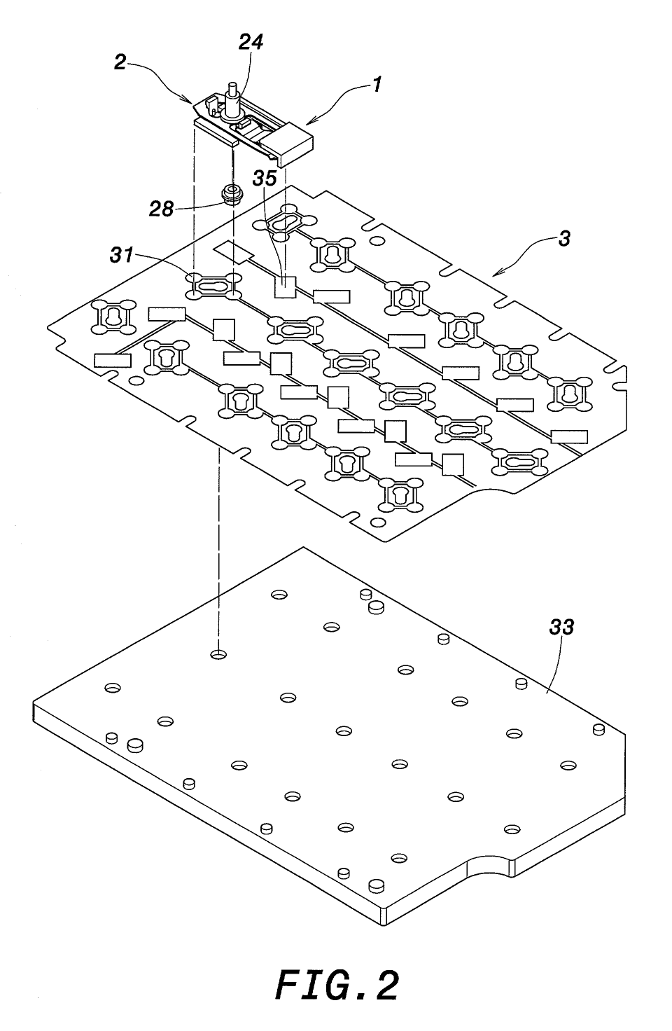

Please refer to FIG. 2, a first circuit 31 of the thin circuit board 3 is soldered onto the body 1 by surface mount technology (SMT), and the thin circuit board 3 has a bottom plate 33 with a specific hardness at its lower section.

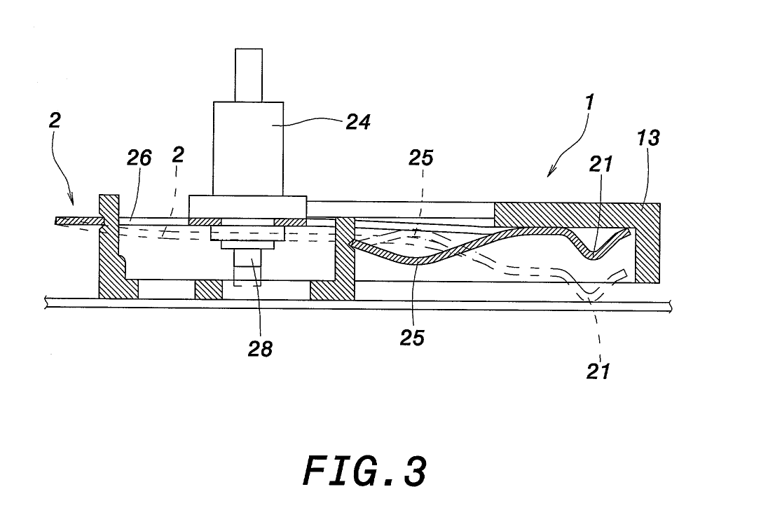

Please refer to FIG. 1. An outwardly extended extension portion 11 is disposed on a side of the body 1, and a lid portoin 13 is disposed at the end of the extension portion 11. The lid portoin 13 locates exactly above the contact portion 21 to prevent the elastic piece 2 from falling off from the body 1. Each of the ends of the body has an upwardly extended second hook portion 26 to work with the first hook portion 15. Those first hook portion 15 are individually coupled with the second hook portions 26 of the elastic portion 25 and on the edge of the second hook portion 26 as shown in FIG. 2 and FIG. 3. The press portion 23, and the body 1 have a through hole 27 and an shaft hole 17 on the corresponding positions of the press shaft 24. An end of the press shaft 24 passes through the through hole 27 and the shaft hole 17, and the body 1 has s durable, slippery, and hollow axle bush 28 being disposed on a position corresponding to that end as shown in FIG. 1 and FIG. 2) such that the up and down movements of the press shaft 24 is restricted to the interior of the axle bush 28.

Please refer to FIG. 3. By means of the foregoing components, when the user presses the press shaft, the press portion 23 will subside so that the elastic portion 25 will bounce, and in the meantime the contact portion 21 will be dragged downward and it will touch the second circuit 35 of the circuit board. Thus, second circuit 35 and the first circuit 31 will be connected. By repeatedly pressing the press shaft 24, the circuit will be connected to produce signals, and further to input related numerals, text, and symbols.

In a preferred embodiment of the present invention, a press shaft 24 is disposed on the top of the press shaft 24 so that the user can press the press shaft 24 more conveniently. The cap can come in different designs for different requirements.

Therefore, in summation of the above description, the present invention having novelty, enhancing performance, and reducing the thickness, having the texture of the mini-switches and the features of long life, easy installation, less components, and low cost which is considered as a perfect utility model that meets the requirements of patentability. It is hereby submitted for patent application. While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A press-button switch structure, comprising:
a body being a electrical conductive material having two ends extended upwardly to a first hook portion; and
a elastic piece being a electrical conductive material coupled to the body, the elastic piece having an end extended downward to contact portions, the elastic piece having an opposite end thereof disposed to an press portion, the elastic piece formed a elastic portion in a punch press between the press portion and the contact portion, the elastic portion having two ends, one end thereof connected to elastic piece, the other end thereof extended downward to second hook portion; the elastic piece having an another second hook portion opposite to elastic portion, the first hook portions hooked to second hook portions, respectively.

2. The press-button switch structure as claimed in claim 1, wherein said body uses a surface mount technology (SMT) to solder a circuit on a thin circuit board at the bottom surface on both side of the body, and the thin circuit board has a bottom plate of specific hardness.

3. The press-button switch structure as claimed in claim 1, wherein the contact portion is gold plated at the bottom thereof to increase conductivity.

4. The press-button switch structure as claimed in claim 1, wherein the press portion coupled to a press shaft.

5. The press-button switch structure as claimed in claim 2, wherein one side of the body having an outwardly extended extension portion, the extension portion having two ends, one end thereof having a lid portoin, wherein the lid portoin upon the contact portion.

6. The press-button switch structure as claimed in claim 4, wherein the Press portion has an through hole coupled to the press portion extend to the shaft hole of the body.

7. The press-button switch structure as claimed in claim 6, wherein said body has a durable, slippery, and hollow axle bush being disposed at a position where the press shaft passes the through hole and an end of the shaft hole, such that the up and down movements of the press shaft are restricted inside the axle bush.

8. The press-button switch structure as claimed in claim 7, wherein said press shaft has a cap top.
